(19) United States
(12) Patent Application Publication
(10) Pub. No.: US 2026/0087244 A1
(43) Pub. Date: Mar. 26, 2026

(54) GENERATIVE RESPONSE MODEL UTILIZING RETRIEVAL AUGMENTED GENERATION AND RESTRICTIVE PROMPT ENGINEERING

(71) Applicant: CDW LLC, Vernon Hills, IL (US)

(72) Inventors: Justin Jones, Chicago, IL (US); Anurag Batra, Alpharetta, GA (US); Michael Andrew Davidson, Yukon, OK (US); Mark J. Pazdan, Deer Park, IL (US)

(21) Appl. No.: 18/894,171

(22) Filed: Sep. 24, 2024

(51) Int. Cl. G06F 40/186; G06F 40/47

(52) U.S. Cl. CPC G06F 40/186; G06F 40/47

(57) ABSTRACT

A computer system for evaluating information technology (IT) documentation including machine learning models, vector databases, processors, and memories to generate responses for queries associated with one or more of: IT problems, IT solutions, or IT devices. A computer-implemented method involving receiving input data including one or more user queries; generating at least one prompt by interpolating the user queries into a template prompt; processing, via an embedding model, the prompt to generate a retrieval vector corresponding to the prompt; retrieving, by querying a vector database using the retrieval vector as an input parameter, one or more retrieval results; processing, using a trained language model, the prompt, the retrieval results and an assistant prompt including a set of assistant instructions for restricting the output of the trained language model; and displaying, via a graphical user interface, one or more responses corresponding to the user queries from the trained language model.

### FIELD OF THE DISCLOSURE

The present aspects relate to computing systems and methods for evaluating information technology (IT) documentation, and more particularly, to systems and methods that utilize machine learning models to respond to questions associated with IT problems, solutions, or devices.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The development and integration of machine learning models, particularly in the realm of language processing, have become increasingly prevalent across various sectors. These models, which include language models, are utilized for a wide array of applications, from automated customer service solutions to sophisticated data analysis tools. Typically, the development and integration of these models necessitate a complex infrastructure that includes specialized software, hardware, and extensive computational resources. This complexity often translates into significant financial and logistical challenges, particularly when it comes to training these models on large datasets to achieve desired levels of accuracy and functionality.

Moreover, the deployment of these models in real-world applications requires seamless integration with existing computing environments, which may not always be readily equipped to handle the demands of advanced machine learning tasks. This can lead to inefficiencies, such as suboptimal data processing and model performance.

Given these considerations, there is a clear need for platforms and technologies that can address the challenges associated with the training, deployment, and integration of machine learning models. There are opportunities for optimized computing environments that can handle the specific requirements of machine learning tasks, thereby enhancing model performance and reducing associated costs. Furthermore, there are opportunities for the development of systems that facilitate easier and more efficient interaction between users and machine learning models, particularly in contexts where natural language processing is a key component.

### BRIEF SUMMARY

Techniques, systems, apparatuses, components, devices, and methods are disclosed for cross-platform network support and network log summarization.

In one aspect, a computing system for cross-platform support and log summarization includes: one or more processors; and one or more memories including computer-executable instructions stored thereon that, when executed by the one or more processors, cause the computing system to: (1) receive, via the one or more processors and from a user device, input data including one or more user queries; (2) generate, via the one or more processors, at least one prompt corresponding to the user queries by interpolating the user queries into a template prompt; (3) process, via an embedding model, the prompt to generate a retrieval vector corresponding to the prompt; (4) retrieve, by querying a vector database using the retrieval vector as an input parameter, one or more retrieval results; (5) process, using a trained language model, (i) the prompt, (ii) the retrieval results and (iii) an assistant prompt including a set of assistant instructions for restricting the output of the trained language model; and (6) display, via a graphical user interface of the user device, one or more responses corresponding to the user queries from the trained language model.

In another aspect, a computer-implemented method for cross-platform support and log summarization includes: (1) receiving, via one or more processors and from a user device, input data including one or more user queries; (2) generating, via the one or more processors, at least one prompt corresponding to the user queries by interpolating the user queries into a template prompt; (3) processing, via an embedding model, the prompt to generate a retrieval vector corresponding to the prompt; (4) retrieving, by querying a vector database using the retrieval vector as an input parameter, one or more retrieval results; (5) processing, using a trained language model, (i) the prompt, (ii) the retrieval results and (iii) an assistant prompt including a set of assistant instructions for restricting the output of the trained language model; and (6) displaying, via a graphical user interface of the user device, one or more responses corresponding to the user queries from the trained language model.

In yet another aspect, a non-transitory computer readable medium contains program instructions that when executed by one or more processors, cause a computer to: (1) receive, via the one or more processors and from a user device, input data including one or more user queries; (2) generate, via the one or more processors, at least one prompt corresponding to the user queries by interpolating the user queries into a template prompt; (3) process, via an embedding model, the prompt to generate a retrieval vector corresponding to the prompt; (4) retrieve, by querying a vector database using the retrieval vector as an input parameter, one or more retrieval results; (5) process, using a trained language model, (i) the prompt, (ii) the retrieval results and (iii) an assistant prompt including a set of assistant instructions for restricting the output of the trained language model; and (6) display, via a graphical user interface of the user device, one or more responses corresponding to the user queries from the trained language model.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary computing environment in which the techniques for evaluating information technology (IT) documentation disclosed herein may be implemented, according to some aspects.

FIG. 2 depicts an exemplary user interface for interacting with the exemplary machine learning models disclosed herein, according to some aspects.

FIG. 3 depicts an exemplary block flow diagram, according to some aspects.

FIG. 4 depicts an exemplary computer-implemented method for evaluating information technology (IT) documentation, according to some aspects.

FIG. 5 depicts an exemplary block flow diagram for developing a large language model assistant, according to some aspects.

FIG. 6 depicts an exemplary large language model architecture, according to some aspects.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

### OVERVIEW

In the rapidly evolving landscape of information technology (IT), the integration and effective utilization of machine learning models, particularly for language processing, have become paramount. The disclosed computing system introduces a novel approach to evaluating IT documentation, significantly enhancing the efficiency, accuracy, and user experience in interacting with complex IT knowledge bases. This system, leveraging a combination of hardware and software components, is designed to optimize the processing of user input related to IT documentation.

In one aspect, a computing system includes one or more processors, memories, one or more machine learning models and/or language models, and one or more vector databases. The ability to receive input data (e.g., queries related to an IT knowledge base or another knowledge base of interest) from a user, and process such input data through the disclosed combination of vector databases and trained language models, provides significant advantages over the conventional techniques. Specifically, this aspect involves generating prompts based on user queries, transforming these prompts into retrieval vectors, and querying a vector database to retrieve relevant IT documentation. The system's trained language model further processes these elements, along with an assistant prompt, to generate responses that are both relevant and restricted to the knowledge base of interest.

This computing system provides significant advantages in processing capabilities. The system's processors work in tandem with the embedding models, the language models, and the vector databases, to efficiently transform user queries into retrieval vectors, process retrieved documents and data using the language models, and generate responses for the user using the language models. This not only streamlines the retrieval of relevant documentation but also provides accurate and useful responses to user queries. The inclusion of an assistant prompt, which guides the language model in generating responses, ensures that the output is relevant to the user's needs while adhering to predefined restrictions that prevent inappropriate or confidential information from being provided to the user. Moreover, this computing system, through the generation of such tailored responses, facilitates the evaluation of IT documentation, thereby decreasing the processing time required to sufficiently analyze IT documentation included in relevant knowledge bases, as compared to the conventional techniques.

Another significant advancement is in the system's ability to dynamically interact with a knowledge base (e.g., a knowledge base database/datastore) through the use of application programming interfaces (APIs). This interaction facilitates the retrieval of relevant documents and additional training data for the machine learning models of the system, enriching the vector databases and improving the accuracy of responses from the language models. The system's capability to determine IT solutions associated with training data and user queries further personalizes the retrieval process, ensuring that the responses are tailored to the specific context of the query and the user.

In summary, the disclosed computing system provides significant advantages in the field of IT documentation evaluation over the conventional techniques. The machine learning models of the disclosed computing system, including embedding models and trained language models, are integrated with a specific hardware architecture that, in combination, provides various solutions to the challenges of processing and evaluating IT documentation. Additionally, the inclusion of vector databases that are generated, at least in part, based on user input data further enhances the trained language model’s ability to generate accurate and informed responses specific to a user’s needs. This approach not only improves the efficiency and accuracy of the evaluation process but also significantly enhances the user experience, by providing new mechanisms of interaction between users and complex IT knowledge bases. Through API utilization and optimized processing capabilities, the system provides a platform for seamlessly managing and troubleshooting IT documentation queries across a diverse range of applications and environments.

### EXEMPLARY COMPUTING ENVIRONMENT

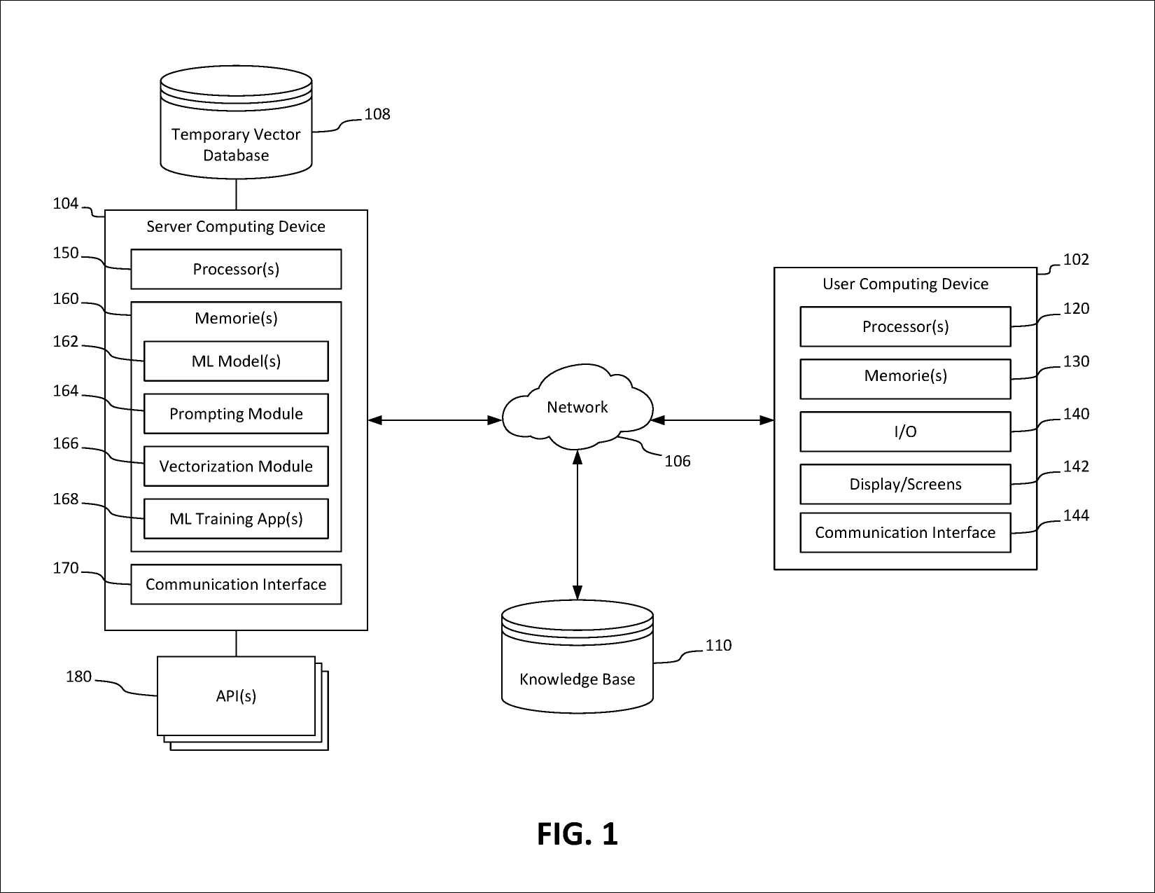

FIG. 1 depicts an exemplary computing environment 100 in which the techniques disclosed herein may be implemented, according to an aspect. The high-level architecture of computing environment 100 includes both hardware and software components, as well as various channels for communicating data between the hardware and software components. The computing environment 100 may include hardware and software modules that employ methods of building, deploying and connecting both hardware and software. The modules may include one or more computer-readable storage memories containing computer readable instructions (i.e., software) for execution by a processor of the computing environment 100. The environment 100 includes a user computing device 102, a server computing device 104, a network 106, a temporary vector database 108, and a knowledge base datastore 110.

The user computing device 102 includes one or more processors 120, one or more memories 130, one or more input/output (I/O) devices 140, one or more displays/screens 142, and a communication interface 144. The user computing device 102 may be any suitable type of computing device or system (e.g., a collection of computing resources). For example, the user computing device 102 may be a mobile computing device, a server computer, a personal computer, a smart phone, a tablet, a laptop, a wearable device, etc. In some aspects, a user computing device 102 may be a personal portable device of a user. For example, the user computing device 102 may be the property of a customer, a company, an organization, etc.

The user computing device 102 may include one or more processors 120 and one or more memories 130. The processors 120 may include any suitable number of processors and/or processor types, such as CPUs and one or more graphics processing units (GPUs). For example, one or more GPUs 120 may be configured and/or used to train the ML models 162, one or more language models, and/or other ML models described herein. Generally, the processors 120 (e.g., one or more CPUs) are configured to execute software instructions stored in a memory (e.g., the memories 130). The memory 130 may include one or more persistent memories (e.g., a hard drive/ solid state memory) and may store one or more sets of computer executable instructions/modules.

The I/O devices 140 may include one or more suitable types of user input devices, such as keyboards, touch screen displays, mice, touch pads, microphones, and/or any suitable types of remote and/or local user input devices. Further, the I/O devices 140 may include one or suitable types of output devices, such as touch screen displays, speakers, and the like. The I/O devices 140 may include one or more local interfaces, and/or may include one or more remote interfaces that are communicatively connected to the user computing device 102 via the network 106 (e.g., that are provided by an application, web browser, or other software executing on a computing device).

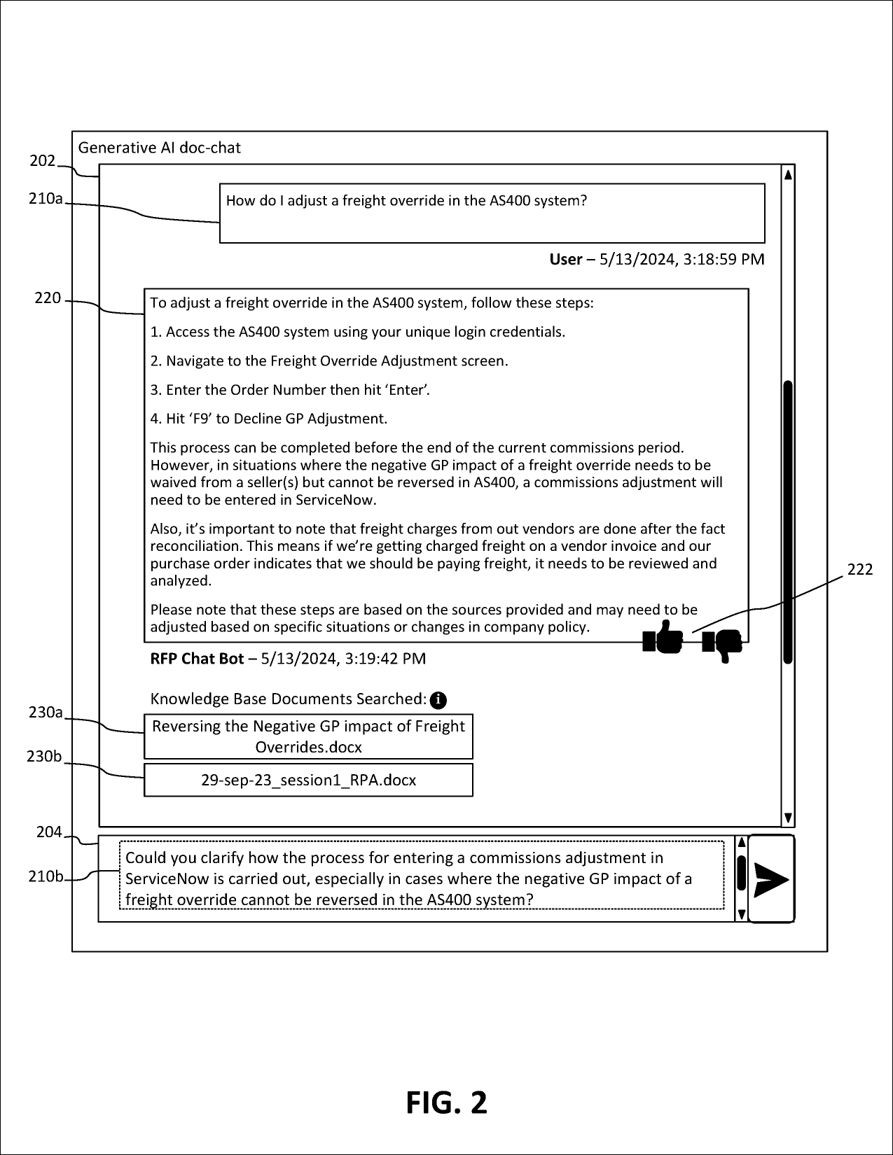

The displays/screens 142 may use any suitable display technology (e.g., LED, OLED, LCD, etc.), and in some embodiments may be integrated with I/O device 140 as a touchscreen display. In some embodiments, the display 142 may not be integral to the user computing device 102 and may receive instructions from the user computing device 102 via wired and/or wireless transmissions over communication interface 144, for example. In an embodiment, I/O device 140 and display 142 may combine to form an integral user interface to enable a user of the user computing device 102 to interact with graphical user interfaces (GUIs) provided by user computing device 102. In some embodiments, a user may input data (e.g., user queries, relevant documentation, RFP questions, etc.) to the computing system 100, and more specifically, to a service account (e.g., a processing email address), via electronic communication means, such as, email, short message service (SMS), etc. Moreover, such input data may be used to generate the temporary vector database 108 and an initial response from the language model. Additionally, a language model interface (e.g., the exemplary user interface 200 of FIG. 2) may be presented/provided to a user (e.g., via a web link, an local or web application, etc.) in response to receiving such input data.

The communication interface 144 includes at least one wireless communication interface which includes hardware, firmware, and/or software that is generally configured to communicate with other devices (including at least other mobile devices) and/or over the network 106, or with the server computing device 104. For example, the communication interfaces 144 may be configured to transmit and receive data using a Bluetooth protocol, a Wi-Fi® (IEEE 802.11 standard) protocol, a near-field communication (NFC) protocol, a cellular (e.g., GSM, CDMA, LTE, WiMAX, etc.) protocol, a peer-to-peer wireless protocol, a short-range wireless protocol, and/or other suitable wireless communication protocols. The communication interface 144 may include one or more transceivers to support various different wireless communication protocols. Additionally, although not shown in FIG. 1, it is understood that, in some implementations, communication interfaces 144 may include one or more wired communication interfaces which may be utilized by the user computing device 102 to communicatively connect to the network 106, the server computing device 104, to the knowledge base datastore 110, and/or to other devices via one or more wired communications or data protocols. In some embodiments, the communication interface 144 may be a network interface controller (NIC) and may include any suitable NICs, such as wired/wireless controllers (e.g., Ethernet controllers), and facilitate bidirectional/ multiplexed networking over the network 106 between the user computing device 102, the server computing device 104, and other components of the environment 100 (e.g., the knowledge base datastore 110, another user computing device, a remote computing device, etc.).

The server computing device 104 may include one or more processors 150, one or more memories 160, a communication interface 170, and one or more application programming interface(s) 180. The server computing device 104 may be an individual server, a group (e.g., cluster) of multiple servers, or another suitable type of computing device or system (e.g., a collection of computing resources). For example, the server computing device 104 may be a server, a mobile computing device, a smart phone, a tablet, a laptop, etc. In some aspects the server computing device 104 may be a personal portable device of a user. For example, the server computing device 104 may be the property of a customer, a company, an organization, etc. In some embodiments, the server computing device 104 may be configured to operate within various cloud computing environments (public clouds, private clouds, hybrid clouds, community clouds, etc.). In such embodiments, the server computing device 104 may utilize cloud resources to enhance its computational power, storage capacity, and data processing capabilities. In some embodiments, the server computing device 104 may create multiple virtual machines, enabling it to host different applications and services in isolated environments.

The server computing device 104 may include one or more processors 150 and one or more memories 160. The processors 150 may include any suitable number of processors and/or processor types, such as CPUs and one or more graphics processing units (GPUs). For example, one or more GPUs 120 may be configured and/or used to train the ML models 162, one or more language models, and/or other ML models described herein, while one or more CPUs may be configured and/or used to perform various other functions of the example computing environment described herein. Generally, the processors 150 are configured to execute software instructions stored in a memory (e.g., the memories 160). The memory 160 may include one or more persistent memories (e.g., a hard drive/ solid state memory) and may store one or more sets of computer executable instructions/modules, including one or more machine learning (ML) model(s) 162, a prompting module 164, a vectorization module 166, and one or more machine learning (ML) training applications 168. It should be understood that, in some embodiments, the memories 130 of the user computing device 102 may store local instances of some or all of the components/modules stored in the memories 160.

The memories 160 may include a ML model 162 for implementing the various techniques described herein. The ML model 162 may be a language model (LM), or a large language model (LLM), that is configured, trained, and/or instructed to generate, for each input to the machine learning model 162 (e.g., inputs including a set of instructions for the ML model 162), a respective output for each input. For example, the ML model 162 may be provided with one or more prompts as an input, the prompts including sets of instructions, questions/queries, additional input data (e.g., contextual and/or historical documents/data), and/or contextual information for responding to the queries/questions. Additionally, the ML model 162 may be trained on historical documents/data related to the knowledge base of interest. For example, in some embodiments, the machine learning model 162 may be trained on historical request for proposal documents and additional relevant historical documents. Generally, the machine learning model 162, or another exemplary machine learning model, may process input data, such as a question or query (e.g., a question from a request for proposal, a query related to a knowledge base of interest, a query related to a previously generated response, etc.), relevant documents (e.g., from the temporary vector database 108 and/or the knowledge base 110), etc., and generate natural language responses based on such input data and/or source documents (e.g., from the vector database 108 and/or the knowledge base 110) associated with the generated responses.

The memories 160 may include a prompting module 164 for implementing various techniques described herein. The prompting module 164 may store a plurality of template prompts, the template prompts including instructions for a language model (LM), such as, the ML model 162, that provide context to the LM and/or cause the LM to provide an output in a specified format. In some embodiments, the prompting module 164 may store a plurality of assistant prompts that include one or more sets of instructions that restrict the output of the LM to: responses to questions related to a knowledge base of interest (e.g., the knowledge base 110), responses to questions that do not require a definitive/absolute response, and/or responses to questions that do not touch on categorically excluded topics (e.g., topics related to confidential, private or sensitive information). The prompting module 164 may include instructions for interpolating one or more questions (e.g., questions from a request for proposal document) and/or queries (e.g., queries regarding IT problems, IT solutions, or IT devices included in input data from a user) into a template prompt.

The memories 160 may include a vectorization module 166 for implementing various techniques described herein. The vectorization module 166 may include an embedding model for vectorizing data and/or documents (e.g., for generating vector representations of data/documents). The embedding model may be any suitable type of embedding model, such as a word embedding models (e.g., Word2Vec, FastText, etc.), document embedding models (e.g., GPT, a bidirectional encoder model, etc.), image embedding models, etc. In some embodiments, the vectorization module 166 may include instructions for generating the temporary vector database 108 based on initial training data, the initial training data having been vectorized by the embedding model. In some embodiments, the initial training data may include one or more questions (e.g., questions from a request for proposal) and a plurality of relevant documents related to the one or more questions. In some embodiments, the initial training data may include key value pairs such as one or more historical questions and associated historical answers to the questions. The vectorization module 166 may include instructions for processing (e.g., via the embedding model) a prompt from the prompting module 164, or a question/query included in a prompt from the prompting module 164, to generate a retrieval vector corresponding to the prompt for querying the temporary vector database 108 using the retrieval vector as an input parameter.

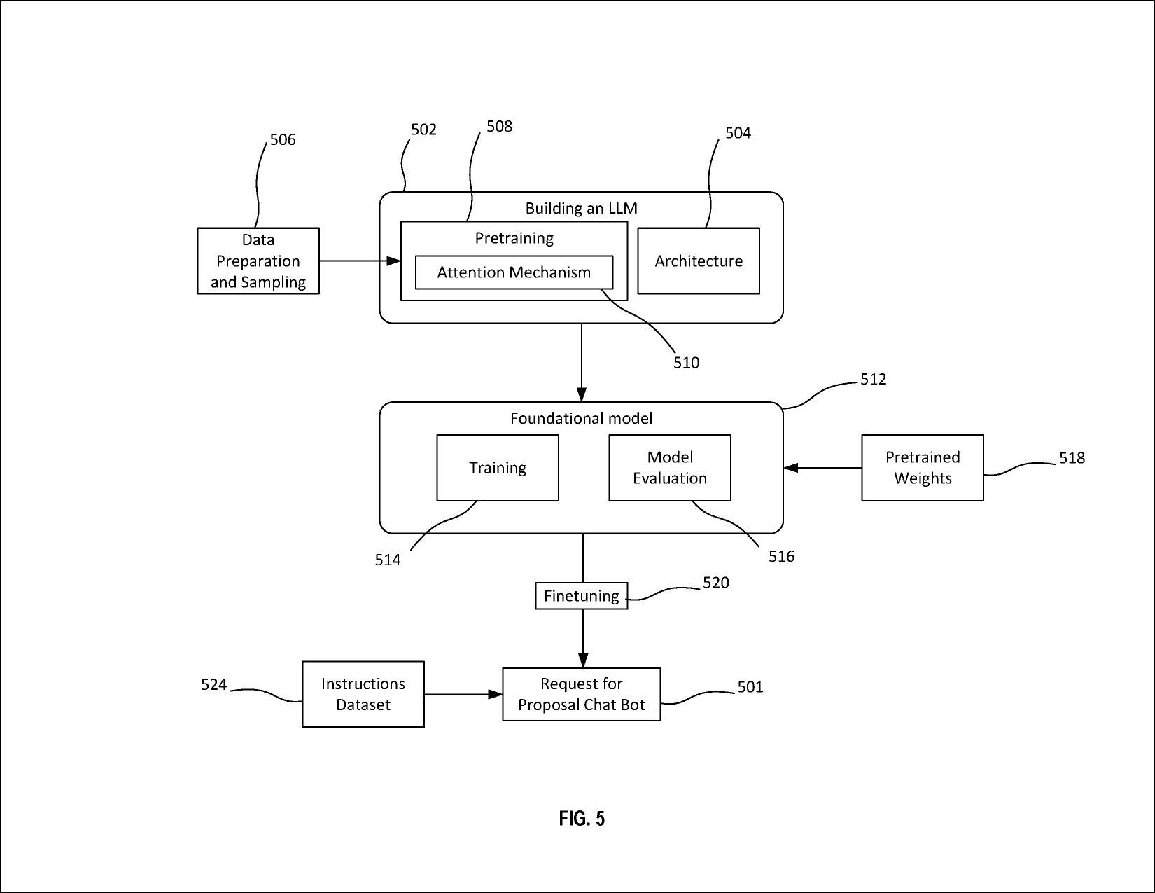

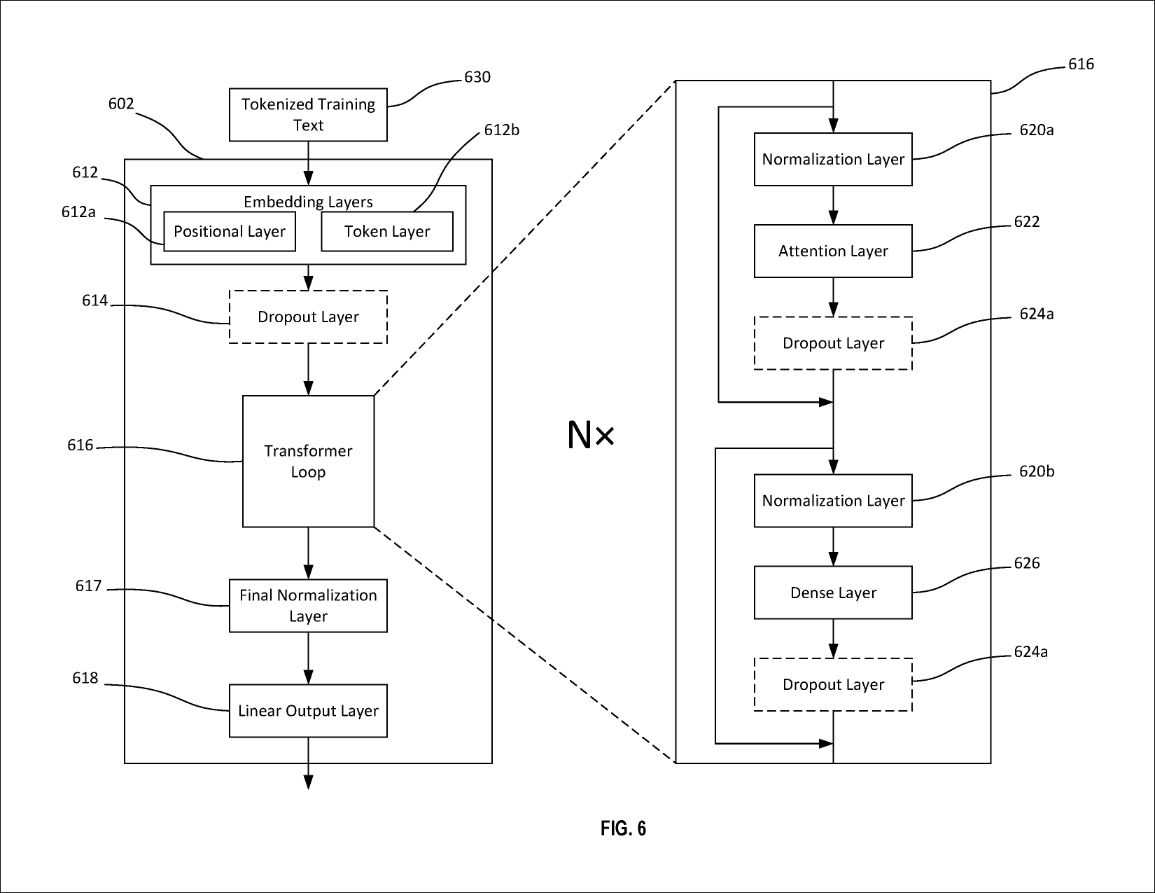

The memories 160 may include one or more machine learning (ML) training applications 168 for training the exemplary machine learning models described herein (e.g., the ML models 162). In some embodiments, the ML training applications 168 may include instructions for training a ML model (e.g., the ML model 162), for example, on historical request for proposal documents and additional relevant historical documents. The ML training application 168 may store various types of training data that may be, for example, extracted from the knowledge base datastore 110. The training/development of the machine learning model 162, or another machine learning model not depicted in FIG. 1, to process input data, is described below with respect to FIG. 5 and FIG. 6.

The application programming interfaces (APIs) 180 may facilitate interaction between components and/or devices of the computing system 100. Generally, the APIs 180 may be configured to receive data, and/or information, from a component of the computing system 100 and to provide such data to a different component of the computing system 100. For example, the APIs 180 may be configured to exchange information between the vector database 108 and the ML model 162. As another example, the APIs 180 may be configured to provide vectorized input data to the ML model 162, the temporary vector database 108, etc. In some embodiments, the one or more APIs 180 may include a computer vision API that includes visual processing model/application, for instance, a convolutional neural network (CNN), an image-to-graph transformer, a graph neural network (GNN), a multilayer perceptron, etc. Generally, an exemplary computer vision API 180 may generate graph representations (e.g., a text file) of visual data, and may provide the graph representations to the one or more ML models 162, thereby enabling the one or more ML models 162 to interpret visual data.

The memories 160 may additionally include instructions for facilitating exchange between the ML models 162 and the APIs 180, although not explicitly depicted in FIG. 1. For example, the memories 160 may include additional instructions for obtaining, by the API 180, a plurality of relevant documents and one or more questions/queries from the user computing device 102, and for inputting the plurality of relevant documents and the one or more questions/queries to the ML model 162. The memories 160 may additionally include instructions for providing input data (e.g., from the user computing device 102) to components/modules of the memories 160 (e.g., providing the input data to the prompting module 162, the vectorization module 166, etc.). Further, the memories 160 may include instructions for obtaining one or more responses from a ML model 162, and for providing the one or more response to the user computing device 102. Additionally, the memories 160 may include instructions for interfacing, via the APIs180, the ML model 162 and the temporary vector database 108. In some embodiments, the memories 160 may include instructions for querying the temporary vector database 108 using a retrieval vector (e.g., a retrieval vector generated via the vectorization module 166) as a input parameter, and obtaining retrieval results (e.g., responsive documents, data, context, etc.) from the temporary vector database 108.

The network 106 may be a single communication network, or may include multiple communication networks of one or more types (e.g., one or more wired and/or wireless local area networks (LANs), and/or one or more wired and/or wireless wide area networks (WANs) such as the Internet). The network 106 may enable bidirectional communication between the client computing device 102, the server computing device 104, the knowledge base datastore 110, and/or between other computing devices, for example.

The computing system 100 may include a temporary vector database 108 for implementing various techniques described herein. The temporary vector database 108 may be communicatively couple to the server computing device 104 and/or the user computing device 102, and in some embodiments, the temporary vector database 108 may be stored in the memories 160, the memories 130, and/or another memory of the computing system 100. In some embodiments, the temporary vector database 108 may be generated based on initial training data (e.g., initial training data input by a user to the user computing device 102, initial training data from the knowledge base datastore 110, initial training data stored in the ML training application 168, etc.). Generally, the initial training data may include questions related to a knowledge base of interest (e.g., a knowledge base corresponding to IT problems, IT solutions, IT devices, etc.) and relevant documents/data. In some embodiments, the initial training data may be vectorized, by the vectorization module 166 and/or an embedding model, for generating the temporary vector database 108

The knowledge base datastore 110 may be an electronic database storing data and/or information related to a knowledge base of interest. For example, the knowledge base datastore 110 may be generated/constructed based upon a knowledge base including requests for proposals and other related documents (e.g., project overviews, case studies, project timelines, etc.). The knowledge base datastore 110 may be communicatively connected (e.g., via the network 106) to the user computing device 102, the server computing device 104, and/or another computing device of the system 100. In some embodiments, the knowledge base datastore 110 may use an information retrieval (IR) system, generally employing query-driven retrieval to obtain files that are responsive to a system query. While not explicitly depicted in FIG. 1, in some embodiments, the computing environment 100 may include an IR system, separate from the knowledge base datastore 110. For example, the computing environment 100 may include, and/or access (e.g., via the APIs 180), various IR systems including search engines, vector databases (e.g., separate from the temporary vector database 108), digital libraries, etc. In some embodiments, the knowledge base datastore 110 may alternatively be an IR system 110.

The ML models 162 (e.g., the language models and embedding models described herein) and the knowledge base datastore 110 (in some embodiments, the IR system) may interface (e.g., via the APIs 180) to facilitate interaction between a user and a knowledge base of interest, thereby providing an advantageous approach to IT documentation evaluation. Moreover, the generation of the vector database 108, using data/documents included in the knowledge base datastore 110, conversion of user queries into retrieval vectors, and subsequent retrieval of relevant data/documents from the vector database 108 and generation of responses to the user queries (e.g., from the language model and based on the relevant documentation) provides advantages in documentation evaluation while imparting a minimized computational load to computing systems. This reduction in the computational load for evaluating complex knowledge bases arises from the vectorization of such knowledge bases and the interfacing of language models, and other ML models, to these vectorized knowledge bases.

### EXEMPLARY USER INTERFACES

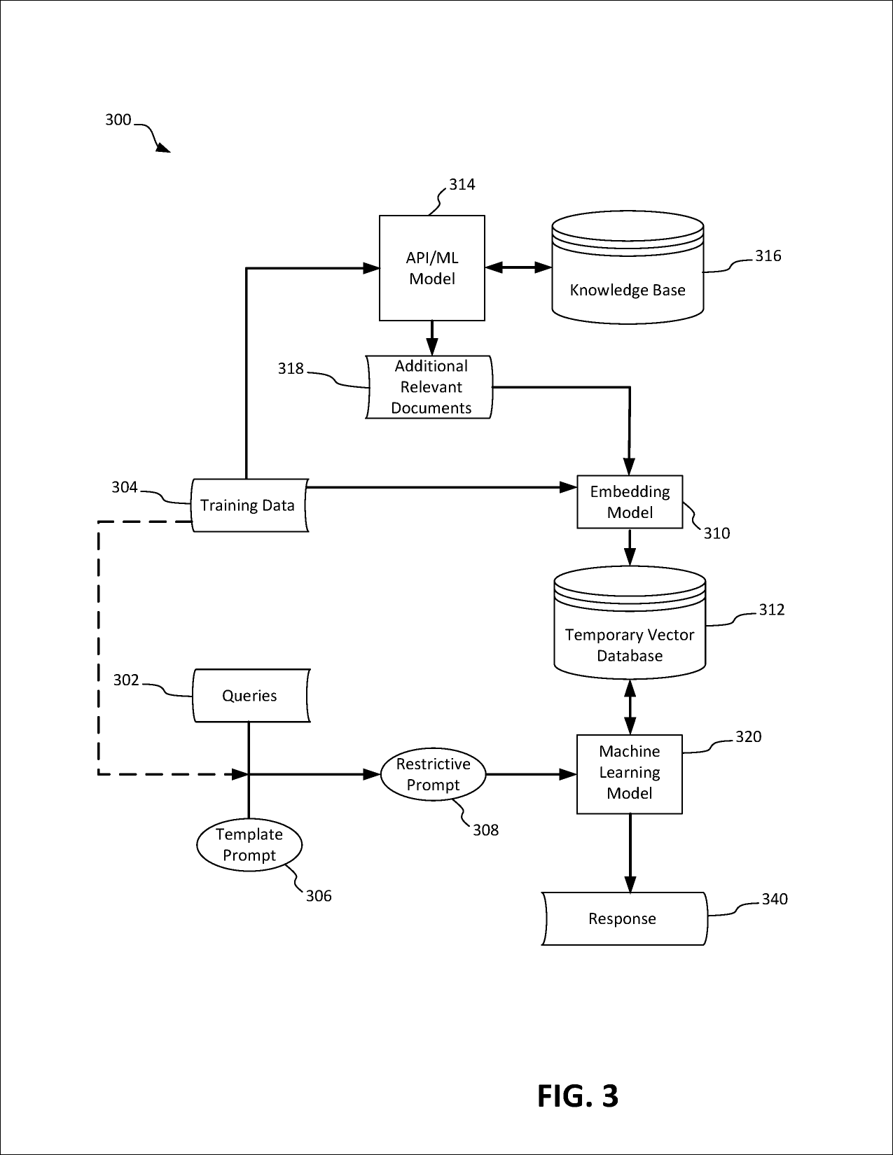

FIG. 2 is an exemplary user interface 200 for interacting, in a conversational format, with the exemplary machine learning (ML) models and/or language models (LMs) described herein, such as the one or more ML models 162 of FIG. 1, the ML model 320 of FIG. 3 (described below), the RFP chat bot 501 of FIG. 5 (described below), and/or other ML models or LMs. The exemplary user interface 200 includes a chat box 202 and a text box 204. In the example scenario, the chat box 202 includes user input 210a, a chat bot response 220, and source documents 230a-230b; and the text box 204 includes user input data 210b. In some embodiments, the user input 210a, or initial user input, may be optional and, instead, the chat bot response 220 may be pre-generated and/or generated in response to other input data.

In some embodiments, the chat bot responses (e.g., chat bot response 220) include feedback buttons 222 allowing a user to indicate a level of satisfaction for the response from the chatbot generated based upon the user input 210. In some embodiments, the chatbot responses may additionally include a time stamp.

The source documents 230 may be documents from the exemplary vector databases described herein, such as the temporary vector database 108 of FIG. 1 generated based upon a plurality of relevant documents and one or more questions included in input data from a user. For example, a plurality of relevant documents and one or more questions may be input to the exemplary computing system(s) described herein (e.g., the exemplary computing environment 100 of FIG. 1), by the exemplary user interface 200 or other user interfaces described herein, and may be used to generate a temporary vector database that may be communicatively interfaced with the exemplary machine learning model utilized by the user interface 200. In some embodiments, the temporary vector database may include additional relevant documents from a knowledge base (e.g., the knowledge base 110 of FIG. 1), and accordingly, the source documents 230 may be documents from the knowledge base.

In operation, the computing system 100 may be accessed by a user (e.g., a proposal specialist, a technical architect, a network engineer, etc. ) and the user may enter input data via a user interface (e.g., using the I/O devices 140 and the displays/screens 142), such as the user interface 200. For example, the input data may include one or more questions or queries for a language model (e.g., the ML model 162). In some embodiments, the questions may be from a request for proposal document, the queries may be related to a request for proposal document, etc. In some embodiments, the input data may also include relevant documents, such as, related historical request for proposal documents and/or other related documents/data. The language model may process such input data, output results or responses for the input data, process the outputs, and display the outputs (e.g., via the displays/screens 142 and/or the user interface 200) for review by the user.

### EXEMPLARY SIGNAL BLOCK FLOW DIAGRAM

FIG. 3 is an exemplary block flow diagram 300 in which the techniques disclosed herein may be implemented. The exemplary block flow diagram 300 includes a query 302, or queries 302, and training data 304. In some embodiments, the training data 304 may include one or more questions and relevant documents related to information technology (IT) problems, IT solutions, IT devices, etc. The exemplary block flow diagram 300 also includes a template prompt 306, a restrictive prompt 308, an embedding model 310, a temporary vector database 312, an application programming interface (API) 314 and/or a machine learning (ML) model 314, a knowledge base datastore 316, additional relevant documents 318, a machine learning (ML) model 320, and a response 340.

The block flow diagram 300 includes interpolating the queries 302 into a template prompt 306 to generate a restrictive prompt 308 (e.g., via the prompting module 164), or one or more restrictive prompts 308 (e.g., one or more restrictive prompts 308 for each of one or more queries 302). In some embodiments, the relevant documents included in the training data 304 may additionally be interpolated with the template prompt 306, along with the queries 302, to generate the restrictive prompt 308. For example, the queries 302 may relate to a specific IT solution (e.g., analytics, cybersecurity, cloud solutions, etc.) and, based on such queries, relevant documents may be retrieved/obtained from the temporary vector database 312 and/or the knowledge base datastore 316. In this example, the relevant documents may be interpolated with the template prompt 306, thereby expanding the contextual understanding of the ML model 314 upon input of the restrictive prompt 308.

The training data 304 may be processed by the embedding model 310 to generate vector representations of the training data 304. The temporary vector database 312 may be generated (e.g., by the vectorization module 166) based upon the vector representations of the training data 304 (e.g., vector representations of the one or more questions and the relevant documents).

The API/ML model 314 may be communicatively coupled to the knowledge base datastore 316, such that the API/ML model 314 can obtain the additional relevant documents 318 from the knowledge base datastore 316 based on the training data 304 (e.g., based on the one or more questions and the relevant documents). In some embodiments, the additional relevant documents 318 may also be vectorized by the embedding model 310 and the vector representations of the additional relevant documents 318 may additionally be used to generate the temporary vector database 312 (e.g., in conjunction with the training data 304).

The exemplary block flow diagram 300 includes processing the restrictive prompt(s) 308 using the ML model 320 to generate the response 340. The ML model 320 may be communicatively coupled to the temporary vector database 312 and, in some embodiments, the embedding model 310. Moreover, the ML model 320 can query the temporary vector database 312 with vector representations of the queries 302 and/or the restrictive prompt 308 in order to access information contained in the relevant documents included in the training data 304 and/or the additional relevant documents 318, before generating the response 340. In some embodiments, the ML model 320 may be configured to provide source documents from the temporary vector database 312 (e.g., documents included in the training data 304 and/or the additional relevant documents 318) with the generated response 340.

### EXEMPLARY COMPUTER IMPLEMENTED METHOD

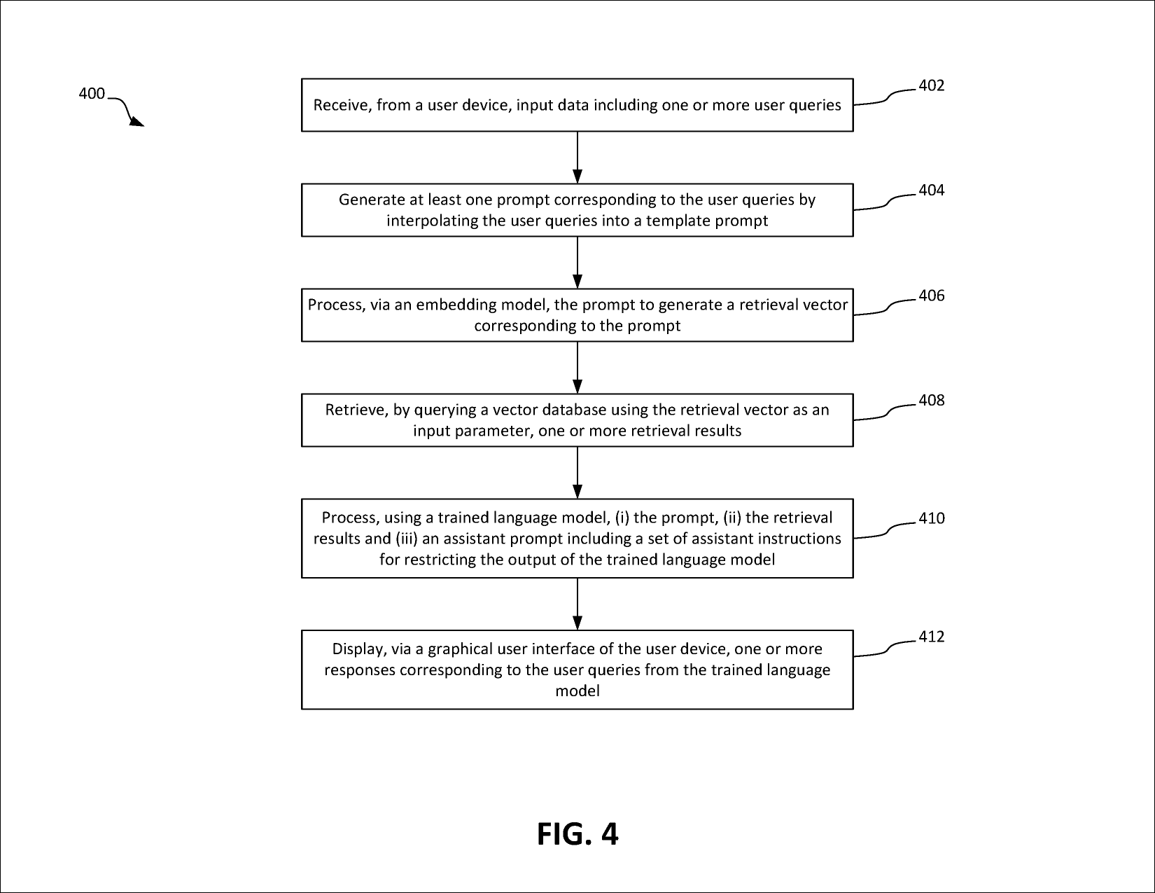

FIG. 4 depicts a computer-implemented method 400 for evaluating information technology (IT) documentation. The method 400 may be implemented by the processors 150, the processors 120, and/or other suitable processors, etc., executing instructions stored on the memories 160, the memories 130, and/or another suitable non-transitory computer readable medium, etc., described above with respect to FIG. 1-3.

The method 400 may include receiving, via one or more processors and from a user device, input data including one or more user queries (block 402). For example, a computing system (e.g., the computing system 100 of FIG. 1) may receive queries from a user via a user interface (e.g., via the displays/screens 142 and the I/O devices 140 of the client computing device 102 from FIG. 1), the queries could be in the form of questions or request for information. Generally, the queries form the basis for generating prompts that will be used to retrieve and process information relevant to the user's request. In some embodiments, the method 400 may include receiving input data (e.g., user queries, relevant documentation, RFP questions, etc.) from a user device via a service account (e.g., a processing email address) utilizing electronic communication means, such as, email, short message service (SMS), etc, and a language model interface (e.g., the exemplary user interface 200 of FIG. 2) may be presented/provided to the user (e.g., via a web link, an local or web application, etc.) in response to receiving the user input data.

The method 400 may include generating, via the one or more processors, at least one prompt corresponding to the user queries by interpolating the user queries into a template prompt (block 404). More generally, the received user queries may be used to generate (e.g., via the prompting module 164 of FIG. 1) a structured prompt by incorporating the queries into a predefined template prompt that ensure the queries are in a form compatible with system’s retrieval and processing mechanisms. Additionally, using a template prompt improves the ability to monitor and refine the prompts generated based on the user queries.

The method 400 may include processing, via an embedding model, the prompt to generate a retrieval vector corresponding to the prompt (block 406). The embedding model (e.g., the embedding model stored in/with the vectorization module 166 of FIG. 1) may transform the prompt, or the user query contained in the prompt, into a vector representation. This vector representation, or retrieval vector, encapsulates the semantic meaning of the prompt, or user query, in a numerical format that can be used to query a vector database (e.g., the temporary vector database 108 of FIG. 1) enabling searching and retrieval of information semantically related to the user query.

The method 400 may include retrieving, by querying a vector database using the retrieval vector as an input parameter, one or more retrieval results (block 408). The vector database contains vector representations of various documents or data, and the query aims to find vectors that are similar or relevant to the retrieval vector. In some embodiments, the method 400 may include generating the vector database based on initial training data including one or more questions and a plurality of relevant documents, the vector database accessible by the trained language model. In some embodiments, the questions and the relevant documents correspond to one or more of: IT problems, IT solutions, or IT devices. In some embodiments, the one or more questions and the relevant documents are included in initial input data from the user device.

The method 400 may include processing, using a trained language model, (i) the prompt, (ii) the retrieval results and (iii) an assistant prompt including a set of assistant instructions for restricting the output of the trained language model (block 410). In some embodiments, the assistant instructions specify that the output of the trained language model: (i) may only provide responses for questions related to a knowledge base of interest, or (ii) must reject questions that require a definitive response. Moreover, the assistant prompt contains instructions that guide the language model (e.g., the ML model 162 of FIG. 1) in generating responses that are relevant to the user's query while adhering to certain restrictions.

The method 400 may include displaying, via a graphical user interface of the user device, one or more responses corresponding to the user queries from the trained language model (block 412). In some embodiments, the prompt includes a set of instructions specifying that the output of the trained language model must include one or more source documents retrieved from the vector database for each of the one or more responses and the method 400 may include displaying, via the graphical user interface, the one or more source documents with the one or more responses. Further, the graphical user interface (e.g., a GUI presented via the displays/screens 164 of the user computing device 102 of FIG. 1) allows the user to review the responses and, in some embodiments, the source documents such that the user can assess their relevance/accuracy and/or glean additional context/information from the source documents. In some embodiments, the method 400 may include obtaining, via the graphical user interface, one or more user responses including one or more of: additional input data, or feedback data.

In some embodiments, the method 400 may include obtaining, via one or more (application programming interfaces) APIs accessible by the knowledge base datastore and the trained language model, the relevant documents from a knowledge base datastore including a corpus of documents corresponding to a knowledge base of interest. In some embodiments, the method 400 may include obtaining, based on the initial training data and via the one or more APIs, additional relevant documents from the knowledge base datastore and upserting, upserting referring to a portmanteau of inserting and updating that means updating an existing vector and/or inserting a new vector if one does not already exist in the vector space, the vector database based on additional training data including the additional relevant documents. Moreover, upserting additional documents/records generally refers to adding, or writing, the additional documents into the vector database. For example, upserting a vector database may include upserting documents: in large batches, into different namespaces/indexes, in parallel, etc. In some cases, upserting the vector database may include attaching metadata and/or key-value pairs, thereby allowing vector queries to be filtered by metadata.

In some embodiments, the method 400 may include determining one or more entities associated with the initial training data and the user queries. In a variation of this embodiment, the method 400 may include generating the vector database by indexing the relevant documents based on a respective entity for each relevant document.

### EXEMPLARY LANGUAGE MODEL BLOCK FLOW DIAGRAM

FIG. 5 depicts an exemplary block flow diagram 500 for developing a request for proposal chat bot 501, according to some aspects. In many embodiments, the request for proposal chat bot 501 may be a language model (LM) such as a large language model (LLM). Building an LLM generally includes implementing a model architecture 504, data preparation and sampling 506, and pretraining 508, as depicted at block 502. The present techniques may include training one or more LMs and/or LLM to predict the next word, or token, in a sequence of words/tokens.

The language model architecture 504 (e.g., the structural design and/or framework of a model) may be selected based upon the intended use case of the language model. For example, the language model architecture 504 may be a transformer architecture, a bidirectional encoder representations from transformers (BERT) architecture, another suitable architecture, or a suitable architecture not yet contemplated in the art.

Data preparation and sampling 506 may include collecting organized and diverse datasets (e.g., massive corpuses of data from the internet or another vast data source) of high quality for training the language model to predict the next token in a sequence of tokens. Exposing a language model to varying linguistic patterns and linguistic nuances may improve the language model’s ability to understand and/or analyze input data and may, consequently, improve the language model’s ability to generate accurate responses (e.g., accurate text responses).

Pretraining 508 may include training a language model on organized and diverse datasets (e.g., the data from data preparation and sampling 506) such that the language model learns general natural language patterns and nuances. Pretraining 508 may additionally include implementing an attention mechanism 510 to provide the language model with improved contextual understanding. Moreover, pertaining 508 converts a language model to a foundational model with a strong understanding of natural language.

The attention mechanism 510 allows a language model to look backwards and forwards (across the token window) when predicting the next token in a sequence and allows the language model to focus on certain types of data (e.g., data that is relevant to the particular application and/or use case of the language model). For example, the attention mechanism 510 may assign a level of importance (e.g., weights) to elements of input data (e.g., words in a sentence). As another example, a self-attention mechanism 510 allows a language model to focus on portions of an input sequence and consider dependencies across the sequence. Additionally, a language model may include one or more attention mechanisms 510, or attention heads 510, allowing the language model to consider local and global context. Moreover, the attention mechanism 510 may provide a language model with the ability to selectively focus on relevant elements of input data while placing less emphasis on other elements of the input data. In contrast, machine learning models/techniques such as recurrent neural networks (RNNs), convolutional neural networks (CNNs), etc., have limited context windows, and consequently struggle to achieve the broad contextual understanding of an input sequence provided by attention mechanism 510. In some embodiments, another learning mechanism, besides the attention mechanism 510, may be implemented to provide the language model with the ability to consider positions of tokens in a sequence, such as a positional encoding mechanism.

Developing a request for proposal chat bot 501 may include training 514 and model evaluation 516 of a foundation model, as depicted at block 512. In some embodiments, pretrained weights 518 may be loaded into a language model. Training 514 may include inputting data to a foundation model to generate response/outputs, calculating a loss based on comparing the models output to ground truth data (e.g., labeled input data), identifying gradients of trainable weights in the model with respect to the calculated loss (e.g., the rate of change of a loss function with respect to the model’s weights), and optimizing the model’s performance to minimize the loss by updating the weights of the model based on the identified gradients. Model evaluation 516 may include evaluating the performance of a foundational model using a validation dataset (e.g., a dataset not included in the training data used to train the model). Moreover, validation loss may be compared to training loss (e.g., the calculated loss above) in model evaluation 516. For example, validation loss of the model exceeding the training loss may be an indication that the language model is overfitting to the training data. In some embodiments, pretrained weights 518 may be loaded into a large language model and may provide a computationally efficient approach/alternative to pretraining a large language model to generate a foundational model.

Finetuning 520 may include training the foundational model on key value pairs (e.g., inputs and desired outputs) such that the foundational model learns to predict a desired output. Finetuning 520 may include adjusting and/or training the final layers of a foundational model. A foundational model may already excel at understanding language and performing natural language oriented tasks. Moreover, by updating the final layers of the foundational model (e.g., leaving the rest of the model frozen while the final layers are trained on task specific data) the contextual understanding of a trained foundational model may be preserved while improving the foundation models performance in the specific task at hand. Additionally, training only the final layers of a foundational model may be less computationally expensive then training the entire model. Additionally and/or alternatively, finetuning 520 may include training all layers of the model on task specific data. In some embodiments, training or finetuning the entirety of a foundational model on task specific data, as opposed to training the final layers of the model, may provide improved performance.

At a high level, the request for proposal chat bot 501 may be generated by finetuning (e.g., finetuning 520) a foundational model. Moreover, the request for proposal chat bot 501 may be a foundational model (e.g., GPT-4, LaMDA, LLaMa, etc.) finetuned on historical request for proposal documents and additional relevant documents (e.g., project overviews, case studies, project timelines, etc.). By finetuning the request for proposal chat bot 501 on such data, more accurate responses may be generated based on user queries related to the corresponding knowledge base.

An instructions dataset 524, or prompts 524, may include natural language instructions and input data for the request for proposal chat bot 501 that cause the request for proposal chat bot 501 to process input data (e.g., in a particular manner described in the instructions dataset 524) and generate a desired output. In some embodiments, key values pairs may be provided within the instructions dataset 524, often termed one shot training. In such embodiments, while the foundational model may not technically be finetuned, one shot training may provide further task-specific context and understanding to the foundational model (e.g., similar to finetuning 520). Moreover and in some embodiments, the request for proposal chat bot 501 may be a foundational model (e.g., a foundational model that has not been finetuned) and the historical request for proposal documents and additional relevant documents may be integrated into the instructions dataset 524 for input to the foundational model.

Generally, prompt engineering may provide additional task specific context and understanding to the request for proposal chat bot 501. For example, in embodiments where the request for proposal chat bot 501 is a foundational model that has not been finetuned, prompt engineering may provide a computationally efficient alternative, or supplement, to finetuning a foundational model. Moreover, a foundational model may effectively by finetuned by providing task specific instructions within natural language prompts (e.g., instructions dataset 524) to the foundational model. Various prompt engineering styles may provide improved performance to the cross platform assistant 501. For example, chain of thought prompting includes instructing a large language model to reach intermediate conclusions (e.g., that may be individually validated) and output such intermediate conclusions in combination with the generated response to the prompt. Such an approach may result in improved results/outputs from large language models, as reaching intermediate conclusions may provide additional context for the model when generating the final output. As another example, iterative prompting may include adjusting a prompt based on the accuracy of the generated output in response to the prompt thereby iteratively refining the prompt. Moreover, prompt engineering may provide the request for proposal chat bot 501, and/or a foundational model, with additional task-specific context and refined instructions that augment the model’s ability to generate accurate responses.

### EXEMPLARY LANGUAGE MODEL ARCHITECTURE

FIG. 6 depicts an exemplary large language model architecture 600 for processing and understanding natural language inputs, according to an aspect. The language model 602 may include embedding layers 612, a dropout layer 614, a transformer loop 616, a final normalization layer 617, and a linear output layer 618. In some embodiments, the embedding layers may include a positional embedding layer 612a and a token embedding layer 612b. The transformer loop 616 may be repeated N times and may include a normalization layer 620a, an attention layer 622, a dropout layer 624a, a normalization layer 620b, a dense layer 626, and a dropout layer 624a. Generally, training text (e.g., the works of Shakespeare) may be tokenized to generated tokenized training text 630 for input to the language model 602. Additionally, the language model 602 operates in a high-dimensional space, or vector space, defined by the internal embeddings and weights of the language model 602 and the language model possesses a particular dimensionality based on the number of features this space. Moreover, the dimensionality of the language model 602 corresponds to the number of tokens that can be represented as a vector in this high-dimensional vector space.

The architecture 600 begins with the embedding layers 612 for converting input text into a format that the model can process. The positional embedding layer 612a may assign a unique position to each word in the input sequence, ensuring the model can recognize the order of words. The token embedding layer 612b may convert each word into a high-dimensional vector, capturing semantic information about the word.

Following the embedding layers, the dropout layer 614 may prevent overfitting by randomly omitting some of the features during training. This ensures that the model remains generalizable to new and unseen data. The core of the architecture is the transformer loop 616, which the model may repeat N times to deeply process the input data (e.g., tokenized training text 630). Within each iteration of the transformer loop, a normalization layer 620a may mitigate vanishing or exploding gradients. Additionally, the normalization layer 620a may ensure the input embeddings (e.g., from embedding layers 612a and 612b) fall within a reasonable range. The normalization layer 620a precedes an attention layer 622 (e.g., attention mechanism 510 of FIG. 5), which may provide the language model 602 with a means for focusing on different parts of the input sequence (e.g., tokenized training text 630) for better understanding. In some embodiments, the attention layer 622 is followed by another dropout layer 624a, which may further aid in generalizing the model for new and unseen data. A second normalization layer 620b and a dense layer 626 succeed the dropout layer 624a, providing additional processing and transformation of the data. The dense layer 626, or a fully connected layer 626, may convert the dimensionality of the output of the model. In some embodiments, the final dropout layer 624b may provide additional robustness and generalization of the model before the loop repeats or concludes.

After exiting the transformer loop, the model may apply a final normalization layer 617 to stabilize the learned features of the input sample text 630. The linear output layer 618 may then converts these features into a format suitable for the specific task at hand, such as classification or text generation. Moreover, the linear output layer 618 produces the predictions of the language model 602 based on the processed set of instructions provided to the language model 602. In some embodiments, although not depicted explicitly in FIG. 6, the language model 602 may include an instructions layer. The instructions layer may process a set of instructions input to the language model 602 and prioritize an instruction in the set over a conflicting instruction based on the relevance and importance of the conflicting instructions.

In operation, users or automated systems may input text into the language model 602. The text may then undergo processing through the described layers (e.g., embedding layers 612, normalization layers 620a-620b, dropout layers 624a-624b, attention layer 622, dense layer 626, etc.) of the language model 602. The language model architecture 600 supports a wide range of natural language processing tasks, enabling it to generate responses, classify text, or even predict subsequent words in a sequence. Users can interact with the language model 602 through various computing environments such as the computing environment 100 of FIG. 1 (e.g., via a graphical user interface, such as the GUI 200 of FIG. 2). The flexibility and depth of processing provided by the language model architecture 600 makes it suitable for complex language understanding and generation tasks, offering significant utility in applications such as personal assistants, chatbots, content creation tools, and more.

### ADDITIONAL CONSIDERATIONS

The following considerations also apply to the foregoing discussion. Although the following text sets forth a detailed description of numerous different aspects, it should be understood that the legal scope of the invention may be defined by the words of the claims set forth at the end of this patent. The detailed description is to be construed as exemplary only and does not describe every possible aspect, as describing every possible aspect would be impractical, if not impossible. One could implement numerous alternate aspects, using either current technology or technology developed after the filing date of this patent, which would still fall within the scope of the claims.

Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence "As used herein, the term " " is hereby defined to mean . . . " or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word "means" and a function without the recital of any structure, it is not intended that the scope of any claim element be interpreted based on the application of 35 U.S.C. § 112(f).

Unless specifically stated otherwise, discussions herein using words such as "processing," "computing," "calculating," "determining," "presenting," "displaying," or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to "one embodiment" or "an embodiment" means that a particular element, feature, structure, or characteristic described in connection with the embodiment is included in at least one embodiment. The appearances of the phrase "in one embodiment" in various places in the specification are not necessarily all referring to the same embodiment.

As used herein, the terms "comprises," "comprising," "includes," "including," "has," "having" or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, "or" refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of "a" or "an" is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computing system for evaluating information technology (IT) documentation comprising:
one or more processors; and
one or more memories including computer-executable instructions stored thereon that, when executed by the one or more processors, cause the computing system to:
receive, via the one or more processors and from a user device, input data including one or more user queries;
generate, via the one or more processors, at least one prompt corresponding to the user queries by interpolating the user queries into a template prompt;
process, via an embedding model, the prompt to generate a retrieval vector corresponding to the prompt;
retrieve, by querying a vector database using the retrieval vector as an input parameter, one or more retrieval results;
process, using a trained language model, (i) the prompt, (ii) the retrieval results and (iii) an assistant prompt including a set of assistant instructions for restricting the output of the trained language model; and
display, via a graphical user interface of the user device, one or more responses corresponding to the user queries from the trained language model.

2. The computing system of claim 1, wherein the assistant instructions specify that the output of the trained language model: (i) may only provide responses for questions related to a knowledge base of interest, or (ii) must reject questions that require a definitive response.

3. The computing system of claim 1, wherein the one or more memories include computer-executable instructions stored thereon that, when executed by the one or more processors, further cause the computing system to:
generate the vector database based on initial training data including one or more questions and a plurality of relevant documents, the vector database accessible by the trained language model,
wherein the questions and the relevant documents correspond to one or more of: IT problems, IT solutions, or IT devices.

4. The computing system of claim 3, wherein the one or more questions and the relevant documents are included in initial input data from the user device.

5. The computing system of claim 3, further comprising:
a knowledge base datastore including a corpus of documents corresponding to a knowledge base of interest; and
one or more application programming interfaces (APIs) accessible by the knowledge base datastore and the trained language model.

6. The computing system of claim 5, wherein the one or more memories include computer-executable instructions stored thereon that, when executed by the one or more processors, further cause the computing system to:
obtain, via the one or more APIs, the relevant documents from the knowledge base datastore.

7. The computing system of claim 5, wherein the one or more memories include computer-executable instructions stored thereon that, when executed by the one or more processors, further cause the computing system to:
obtain, based on the initial training data and via the one or more APIs, additional relevant documents from the knowledge base datastore; and
upsert the vector database based on additional training data including the additional relevant documents.

8. The computing system of claim 3, wherein the prompt includes a set of instructions specifying that the output of the trained language model must include one or more source documents retrieved from the vector database for each of the one or more responses; and
wherein the one or more memories include computer-executable instructions stored thereon that, when executed by the one or more processors, further cause the computing system to:
displaying, via the graphical user interface, the one or more source documents with the one or more responses.

9. The computing system of claim 3, wherein the one or more memories include computer-executable instructions stored thereon that, when executed by the one or more processors, further cause the computing system to:
determine one or more entities associated with the initial training data and the user queries.

10. The computing system of claim 9, wherein the one or more memories include computer-executable instructions stored thereon that, when executed by the one or more processors, further cause the computing system to:
generate the vector database by indexing the relevant documents based on a respective entity for each relevant document.

11. The computing system of claim 1, wherein the one or more memories include computer-executable instructions stored thereon that, when executed by the one or more processors, further cause the computing system to:
obtain, via the graphical user interface, one or more user responses including one or more of: additional input data, or feedback data.

12. A computer-implemented method for evaluating information technology (IT) documentation, the method comprising:
receiving, via one or more processors and from a user device, input data including one or more user queries;
generating, via the one or more processors, at least one prompt corresponding to the user queries by interpolating the user queries into a template prompt;
processing, via an embedding model, the prompt to generate a retrieval vector corresponding to the prompt;
retrieving, by querying a vector database using the retrieval vector as an input parameter, one or more retrieval results;
processing, using a trained language model, (i) the prompt, (ii) the retrieval results and (iii) an assistant prompt including a set of assistant instructions for restricting the output of the trained language model; and
displaying, via a graphical user interface of the user device, one or more responses corresponding to the user queries from the trained language model.

13. The method of claim 12, wherein the assistant instructions specify that the output of the trained language model: (i) may only provide responses for questions related to a knowledge base of interest, or (ii) must reject questions that require a definitive response.

14. The method of claim 12, further comprising:
generating the vector database based on initial training data including one or more questions and a plurality of relevant documents, the vector database accessible by the trained language model,
wherein the questions and the relevant documents correspond to one or more of: IT problems, IT solutions, or IT devices.

15. The method of claim 14, further comprising:
obtaining, via one or more APIs, the relevant documents from a knowledge base datastore.

16. The method of claim 14, further comprising:
obtaining, based on the initial training data and via one or more APIs, additional relevant documents from a knowledge base datastore; and
upserting the vector database based on additional training data including the additional relevant documents.

17. The method of claim 14, wherein the prompt includes a set of instructions specifying that the output of the trained language model must include one or more source documents retrieved from the vector database for each of the one or more responses; and
wherein the method further comprises:
displaying, via the graphical user interface, the one or more source documents with the one or more responses.

18. The method of claim 14, further comprising:
determining one or more entities associated with the initial training data and the user queries.

19. The method of claim 18, further comprising:
generating the vector database by indexing the relevant documents based on a respective entity for each relevant document.

20. A non-transitory computer readable medium containing program instructions that when executed by one or more processors, cause a computer to:
receive, via the one or more processors and from a user device, input data including one or more user queries;
generate, via the one or more processors, at least one prompt corresponding to the user queries by interpolating the user queries into a template prompt;
process, via an embedding model, the prompt to generate a retrieval vector corresponding to the prompt;
retrieve, by querying a vector database using the retrieval vector as an input parameter, one or more retrieval results;
process, using a trained language model, (i) the prompt, (ii) the retrieval results and (iii) an assistant prompt including a set of assistant instructions for restricting the output of the trained language model; and
display, via a graphical user interface of the user device, one or more responses corresponding to the user queries from the trained language model.
